(19) United States
(12) Patent Application Publication
(10) Pub. No.: US 2008/0100412 A1
(43) Pub. Date: May 1, 2008

(54) Insulated shockproof fuse

(76) Inventor: Han-Ming Lee, Hsin Chu City (TW)

Correspondence Address: Lee, Han-Ming, P.O. BOX 7-820, TAIPEI, omitted

(21) Appl. No.: 11/543,433

(22) Filed: Oct. 6, 2006

(51) Int. Cl. H01H 85/24

(52) U.S. Cl. 337/225

(57) ABSTRACT

This invention is an insulated shockproof fuse with the main characteristic that it is wrapped by two semicircle shockproofs works to a ladder-like round rod, its two ends are extended outside to a suitable length and bended as 90 degree to make 2 electrically conductive hats hasped inversely at the corner of 90 degree together as a whole to allow the two ends of electrically conductive hats to be embedded in typical cutout case, it will be fused while unusual high voltage passing through and prevent the electricity discharging through the electric ions in the air by the sealed insulated materials at two sides, thereby achieve the manufacturing effect in blocking the momentary passing of high voltage effectively and preventing the electrical appliances from being damaged.

### BACKGROUND OF THE INVENTION

The typical electrical appliances are used by connecting the plug into the socket, even cascading together the extension cords into one socket. However, the danger of sparking on electric wire under this action is well known. Even the manufacturers today all put the fuses in the outlets to prevent the danger of the overload and overheated (this traditional design is to put the fuse on the glass tube and solder the copper hats at two ends, see FIG. 6, to achieve safe practice with power off in overheated fuse), it is easy to have the electric ions in the air of glass tube discharge under the thunder shock or the momentary passing of high voltage to become the conductive intermediary and damage the components of electric appliances. With those potential danger and defects, it cannot satisfy the need of life security for people nowadays and improvement is required.

### SUMMARY OF THE INVENTION

The primary purpose of this invention is to provide an insulated shockproof fuse with its two ends extended outside to a suitable length and bended as 90 degree to make 2 electrically conductive hats hasped inversely at the corner of 90 degree together as a whole to ensure security by fusing while momentary high voltage passing.

The second purpose of this invention is to provide an insulated shockproof fuse featuring that it is wrapped by two semicircle shockproof works and will, by the sealed insulated materials at two sides, prevent the electricity from discharging through the electric ions in the air. It will block the momentary passing of high voltage effectively and prevent the electrical appliances from being damaged thus, claiming the feature of security performance.

Another purpose of this invention is to provide an insulated shockproof fuse that the insulated materials at two sides can add its gauge to prevent the high voltage conducting to another electrically conductive hat from outside, ensuring the completely insulated shockproof fusing.

### BRIEF DESCRIPTION OF THE DRAWINGS

FIG. 1 is the example of the best practice for this invention.

FIG. 2 is the decomposition diagram of the components in this invention.

FIG. 3 is the composition diagram of components in this invention.

FIG. 4 is the illustration of the conductive hats embedded in the cutout case on this invention.

FIG. 5 is the function illustration of insulated works blocking electricity conduction in this invention.

FIG. 6 is the illustration of the electricity discharging through the electric ions in the air on the past fuses.

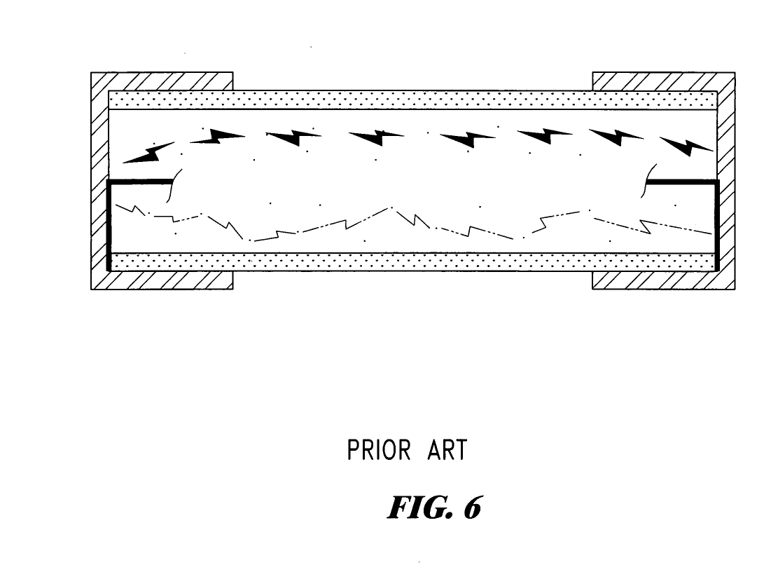

### DELTAILED DESCRIPTION OF THE PREFERRED EMBODIMENT

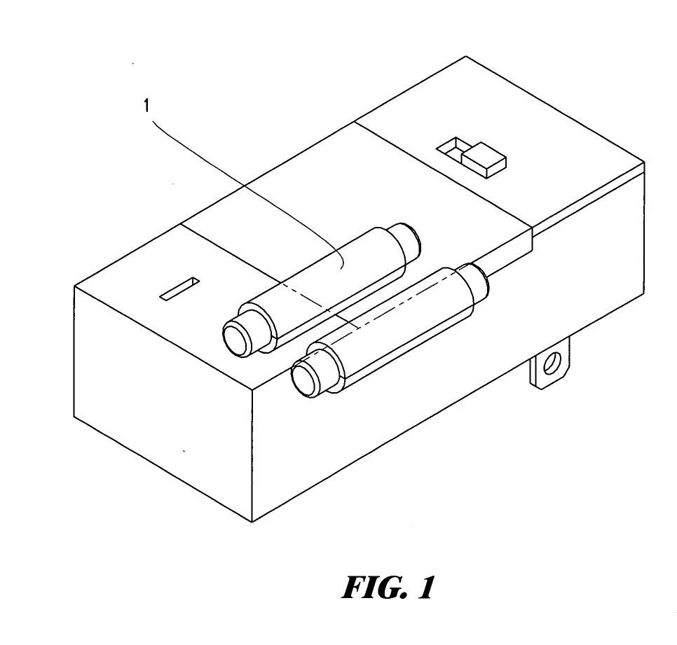

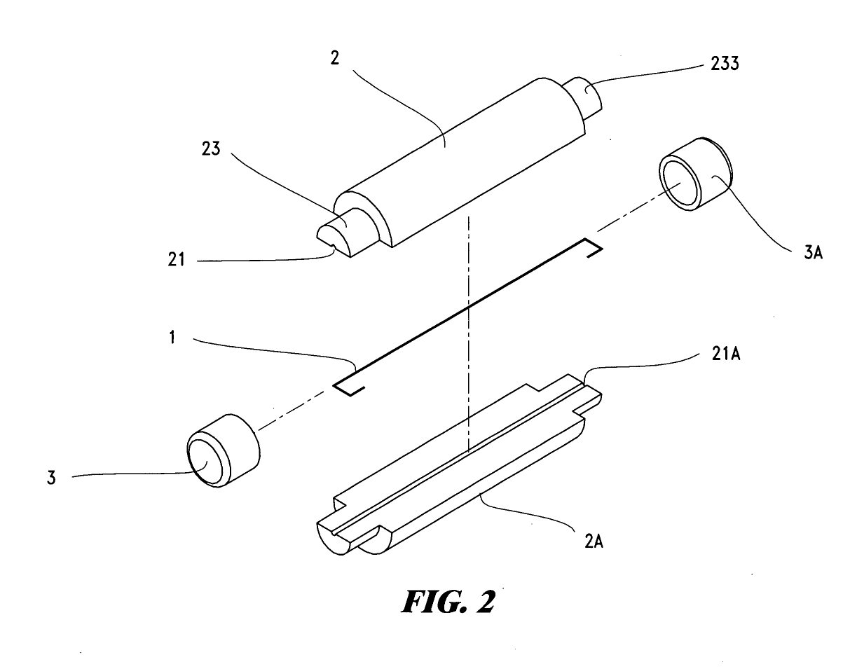

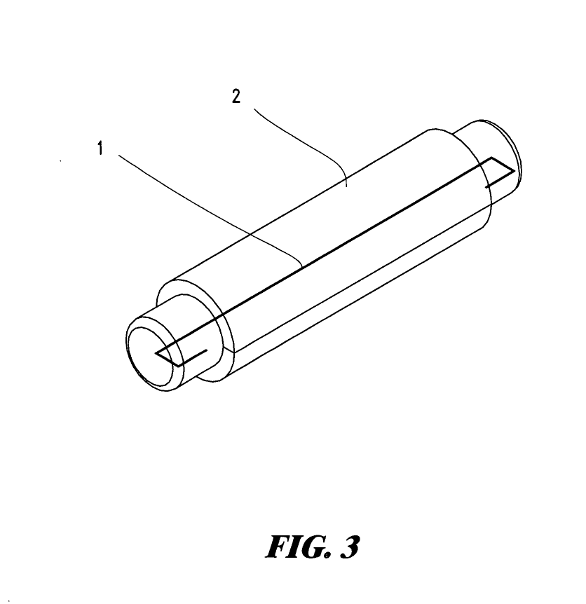

Referring to FIGS. 1 through 3, the prior is an insulated shockproof fuse. Its main characteristics are: the material of Fuse 1 is metal for electric melting; two insulated works 2 and 2A are two semicircle insulated works with the ladder shape whose two opposite central line with concave have arc-groove, 21 and 21A; two electrically conductive hats 3 and 3A are conductive metals with the shape of circle hats separately; the two ends of the fuse are bended as 90 degree by loop 23 and 233 to make the two conductive hats 3 and 3A hasped inversely at the corner of 90 degree together as a whole.

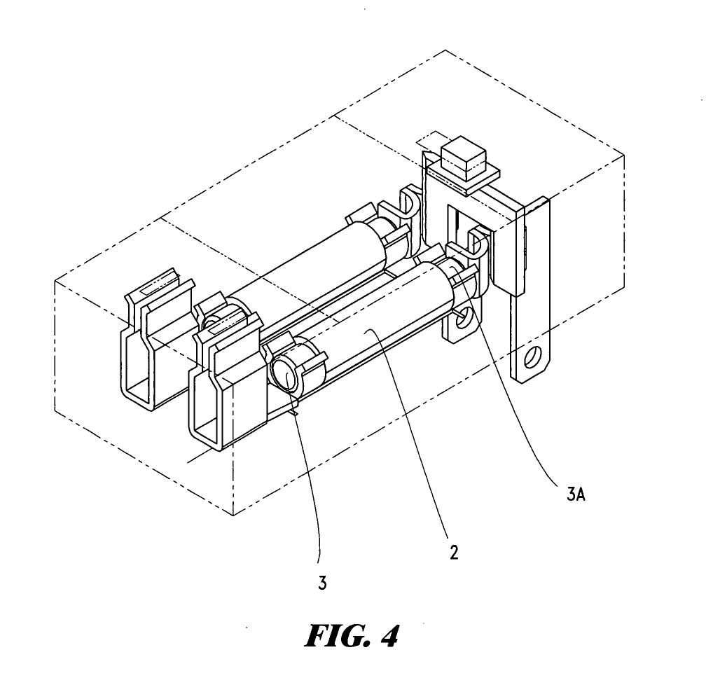

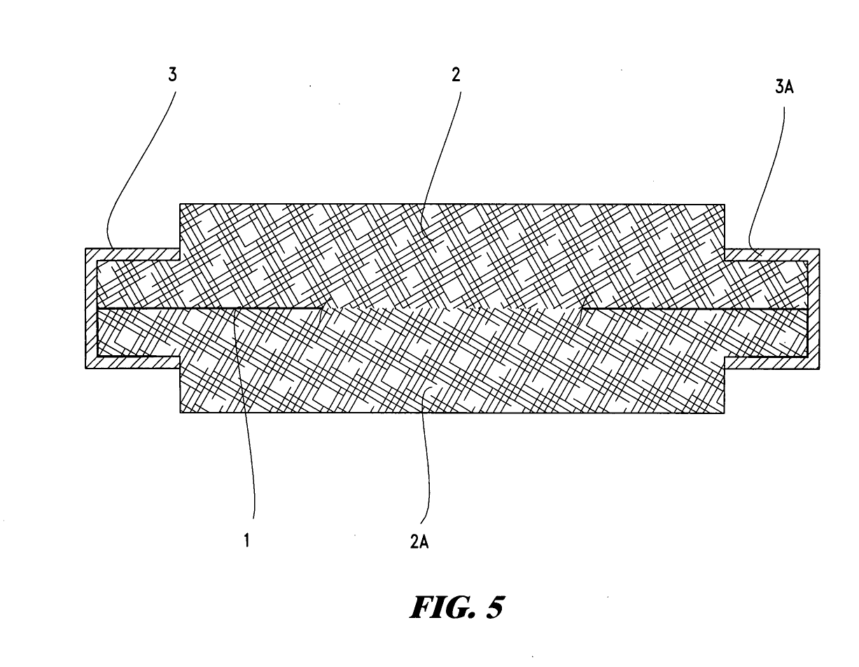

The application of the prior art, see FIG. 4 to FIG. 5, is to embed the two ends of conductive hats 3 and 3A in the usual cutout case. When unusual high voltage passing through, it will be fused momentarily and prevent completely the electricity from discharging through the electric ions in the air by the sealed insulated materials at two sides, thereby achieve the manufacturing effect in blocking the momentary passing of high voltage effectively and preventing the electrical appliances from being damaged.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changers in the forms and details of the device illustrated and in its operation can be made by those skilled in the art without departing in any way from the spirit of the present invention.

What is claimed is:

1. This is an insulated shockproof fuse comprised of fuses, two insulated works, and two conductive hats. Among them, the material of fuses is metal for electric melting; two insulated works are two semicircle insulated works with the ladder shape whose two opposite central line with concave have arc groove for the fuse to put in as ladder-like round rod to form two outside protruded loops at two ends of insulated works; two conductive hats are conductive metals with the shape of circle hats separately; the two ends of the fuse are bended as 90 degree along the loops to make two conductive hats hasped inversely at the corner of 90 degree together as a whole;
With the composition mentioned above, it will allow the two ends of electrically conductive hats to be embedded in the typical cutout case to be fused momentarily while unusual high voltage passing through and prevent the electricity discharging through the electric ions in the air by the sealed insulated materials at two sides, thereby blocking the momentary passing of high voltage effectively and preventing the electrical appliances from being damaged thus, claiming the feature of security performance.Fiber Actinoid Heat Sink according to claim 1 or 2, of which its fibers could be extendedly weaved as heat sink net.
